(19) United States
(12) Patent Application Publication
(10) Pub. No.: US 2007/0146649 A1
(43) Pub. Date: Jun. 28, 2007

(54) Cube shaped lamp and projection device for single slide or digital projection

(76) Inventors: Simon Richard Daniel, Surrey (GB); Christopher Verity Wright, Stroud (GB)

Correspondence Address: CONLEY ROSE, P.C., P. O. BOX 3267, HOUSTON, TX, 77253-3267, US

(21) Appl. No.: 10/596,404

(22) PCT Filed: Dec. 6, 2004
(86) PCT No.: PCT/GB04/05110

§ 371 Date: Jun. 12, 2006

(30) Foreign Application Priority Data
Dec. 12, 2003 (GB) 0328873.5

(51) Int. Cl. G03B 21/28

(52) U.S. Cl. 353/99; 353/119

(57) ABSTRACT

A lamp and projection device for a single slide or digital imaging means comprising six substantially identical faces assembled to form a cube body which supports an illumination system consisting of a light-emitting unit, a electrical transformer unit and switches, a plurality of reflecting mirrors and at least one condensing lens, and a slide or digital light engine. Said overall cube body having a hinged face at the top supporting a reflecting mirror on the inside surface which can be positioned at any angle to allow projecting an image onto a ceiling or onto an adjacent surface, with a micro-switch acting to switch on the device when opened. Said lens being adjustable by means of an external button to enable focusing. The overall faces being formed from a semi-translucent material to enable soft illumination. Said overall device being implemented as a single slide projector/decorative lamp, digital photo projector or video projector.

### BACKGROUND OF THE INVENTION

1) Field of the Invention

This invention relates to a cube shaped lamp and projection device which when opened can project a single slide or digital image onto a ceiling, wall or projection surface. The present invention in a preferred embodiment comprises six substantially flat and identically moulded side casings that are modular and can be assembled to form a cube with the top surface hinged so as to provide a lid and reflection surface capable of being projecting at various angles and also soft illumination through semi-translucent cube panels. In a further embodiment the projection apparatus uses a translucent LCD in place of the slide or a digital light engine where a corner mirror is a digital micro-mirror device (DMD) with associated filters, light tunnel and colour wheels to provide a projection device capable of projecting either static digital photographs from inserted electronic data media or a video or computing display.

2) Description of the Prior Art

There is substantial and diverse prior art dating over the last century on various inventions and designs for slide or digital projectors and lamps in general, including some recent art. However, no such prior art has all the features described and claimed herein. As an example no such examined prior art discloses the cubic assembly using modular panels which make use of a hinged mirrored cube lid to project the image onto a desired projection surface. Furthermore, our invention uses modular interlocking panels that provide an innovative arrangement of support structures and grooves that fix the internal parts of the illumination system depending on their rotation and orientation. Nor does prior art provide for a single slide projector which uses the side casing in such an ornamental design as described herein to function as a soft illumination lamp.

The majority of prior art on simple slide projectors teaches optical arrangements for advanced focusing of slide projectors or photographic enlargers, mechanisms for automating slide movement or combinations with audio-visual elements, combinations with modern LCD and LED projection technology or novel optical arrangements for projecting regular images from off-axis angles, or combination with projection clock elements. Few examples disclose single slide projectors which in general relate to novelty lights, hand-held or portable viewers of single slides rather than custom devices for projecting single slides.

By way of example U.S. Pat. No. 5,517,264 by Sutton discloses a projector night light where a slide is displayed directly onto a viewer display within the lamp and also onto a ceiling. Similarly U.S. Pat. No. 5,311,226 by Karasawa discloses a toy projector with local illumination of ornamental shapes around the lighting box. U.S. Pat. No. 5,247,192 by Pan discloses a projection clock using a reflective clock surface as the image.

In terms of recent ornamental designs U.S. Pat. D400,553 by Kung discloses a ornamental design for a portable slide projector. U.S. Pat. D0474301 by Seal discloses a recent ornamental design for a projector lamp and references some further recent examples.

To the best of the applicant's knowledge, the prior art, whilst suggesting some features and numerous variations relevant to slide projectors and lights in general, the prior art has not disclosed some of the highly advantageous features of the present invention discussed herein.

### SUMMARY OF THE INVENTION

The lamp and projection device of the present invention, in its preferred embodiment, comprises a cube shaped assembly constructed from six identical modular faces that interlock at the edges by means of adjacent recesses and protrusions on opposed edges. Said cube shaped assembly forms a box containing an illumination and projection system consisting of a lamp or at least one light-emitting unit, a electrical transformer unit and switches, a plurality of reflecting mirrors and at least one condensing lens arranged in a suitable optical arrangement around a mid vertical axis of the cube where a slide or digital means can be positioned. The top face of the cube functions as a lid which is arranged to be hinged at one edge and to support a mirror on the inside surface and is capable of being positioned at any angle between a closed position and an open perpendicular position such that it can project an image of a slide onto a nearby wall or projection surface, or onto a ceiling when fully open. Said lid would compress a micro-switch when closed to turn the lamp off or on when opened. Said faces are designed to have an identical interior structure consisting of grooves and support structures that hold and fix the components of the illumination and projection system such as the reflecting mirrors, lens holder, bulb holder and electrical components. These faces are designed such that grooves perform different functions (e.g. hold a slide or lens holder) or are not used depending on their position and rotation in the cube assembly. The interior of the cube also houses a sheet metal bulb holder which is bent and punched to hold a lamp and dissipate heat and to slot into appropriate grooves in the cube side casing as well as to reduce vertical light leakage. Said lens is arranged to be supported in a holder which slots into grooves in the cube side casing and passes through a punched recess in the casing to connect to a control button in such a manner as to enable vertical sliding and control of lens position for focusing. The overall geometry of the cube and symmetrical arrangement of bulb, lens and mirrors about the central cube axis containing the slide provides a simple but effective optical arrangement for projection of a single slide. Said bulb is positioned close to the central axis and in a preferred embodiment consists of a low voltage parabolic bulb of specific spread matching the geometry of the cube so as to provide equal illumination across the slide surface.

The overall faces of the cube in a preferred embodiment are formed from a semi-translucent and coloured material to enable soft illumination and glowing of the whole cube such that the device acts both as a soft lamp and also as a controlled single slide projector via the movable mirrored lid onto an appropriate surface.

A significant feature of the device is that the main body can be assembled from six identical pieces lending itself to low cost manufacture, e.g. by plastic injection moulding with a suitably heat resistant plastic.

A further benefit of the design is that the hottest part of the device surrounding the bulb can be formed at low cost from a punched and folded metal sheet which slots into the plastic side-casing and is designed to dissipate heat via vents and folds. A specific benefit of the overall cube design is that the device lid is always open at an angle when the lamp is on helping to provide a large open cross-section of air-flow to help cool the overall device through air circulation, as well as to provide the user with easy control on projection.

An additional benefit of the six side cube assembly via moulding is in the provision of suitable cavities passing almost all the way through the side that are punchable during installation to enable the overall device to be fixed to a surface or wall and used as a wall lamp. Similar cavities would also be used in a preferred embodiment to imprint text of logos and enable brighter illumination through the cube or to cast a suitable ornamental shadow onto a nearby surface.

A further benefit of the device is that the slide can be changed by moving the lens holder down when the device is turned off by means of an external switch. This enables the user to substitute their own slides. By way of example the device could be used to project a circular slide image of a planet or moon onto the ceiling and used as a night light, or contain nature or landscape images or family portraits onto a ceiling or wall, or used in interior decoration, museums, retail situations or entertainment situations to cheaply project suitable imagery onto a nearby surface. The low cost of the device has the benefit that a plurality of devices could be used in a linear arrangement on a wall or corridor to project anything from single letters, to multiple graphics or different colours.

The overall device therefore provides an aesthetic cubic arrangement which can be used in a variety of manners and provides control for single slide projection as well as soft illumination and is designed from few unique parts for low cost manufacture using in a preferred embodiment a single lens and bulb source without a need for a mechanical cooling fan due to the overall design, metal heat vents and open top.

In a further embodiment the central slide element could be implemented as a digital means such as a translucent LCD panel, or alternatively a corner mirror could be implemented as a digital micro-mirror device (DMD) or LCOS (liquid Crystal on Silicon), with appropriate additional optical components including bulb filters, optical light tunnels and a high speed rotation colour transparency wheel (that acts in a precise rotational synchronization with a microcomputer device controlling the micro-mirror device to reflect and form different colours appropriately). Said overall device reading digital images from either a data storage media device, or by wire or wireless means. The device being usable as a digital image projector where digital images can be displayed in a similar manner to single slides and potentially achievable with lower refresh rate LCD or low technology DLP and reduced micro-computer complexity. Similarly in a full implementation with a DMD or LCOS light engine could be combined with more complex microcontroller to enable RGB and Video projection.

A particular benefit of the Digital Photo Cube device is that it provides an assembly suitable aesthetically and practically for a home environment, being easily mountable or storable in a variety of places with flexibility of projection surface afforded by the angled mirror. The device providing via digital media slots such as flash memory, USB or wireless connectivity, an easy means of projecting digital photographs in the home.

Similarly the compact assembly reduces the complexity of installing the device for a home cinema application or with an electronic games box, as could be used on a coffee table, shelf, bed-side table or fixed onto a wall bracket.

### BRIEF DESCRIPTION OF THE DRAWINGS

FIG. 1 shows a three dimensional view of the overall lamp and projector device.

FIG. 2 shows a three dimensional view of the overall lamp and projector device with one cube face removed for clarity.

FIG. 3 shows a three dimensional exploded view showing the key components and device assembly

FIG. 4 shows a three dimensional view of the metal support plate for the bulb

FIG. 5. shows a view of the modular cube side casing showing the arrangement of grooves and support structures.

FIG. 6. shows a three dimensional view of the overall projection device supporting external slots for removable digital electronic media, or digital connectivity.

FIG. 7. shows a cross-sectional view of the overall projection device where a corner mirror has been replaced with a digital micro-mirror device and associated components to enable the overall device to project static digital photographs or a video/RGB projection.

### DESCRIPTION OF PREFERRED EMBODIMENTS

The preferred embodiments of the invention will now be described with reference to the accompanying drawings herein:

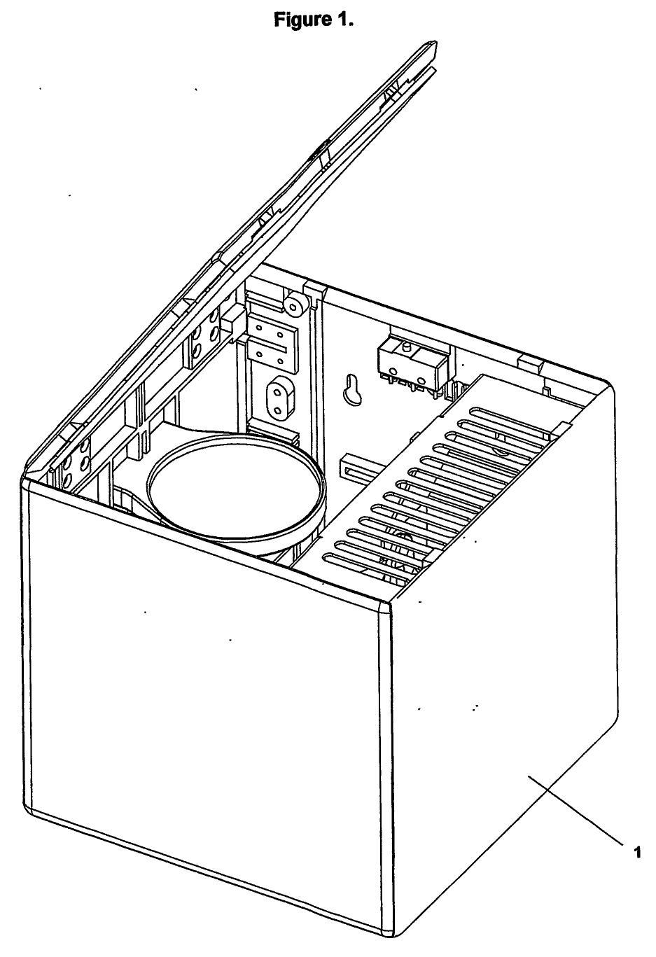

Referring to FIG. 1, which shows the overall lamp and projection device 1 when fully assembled showing the lid 7 open at an angle to project an image onto a nearby wall surface as it might appear when in use.

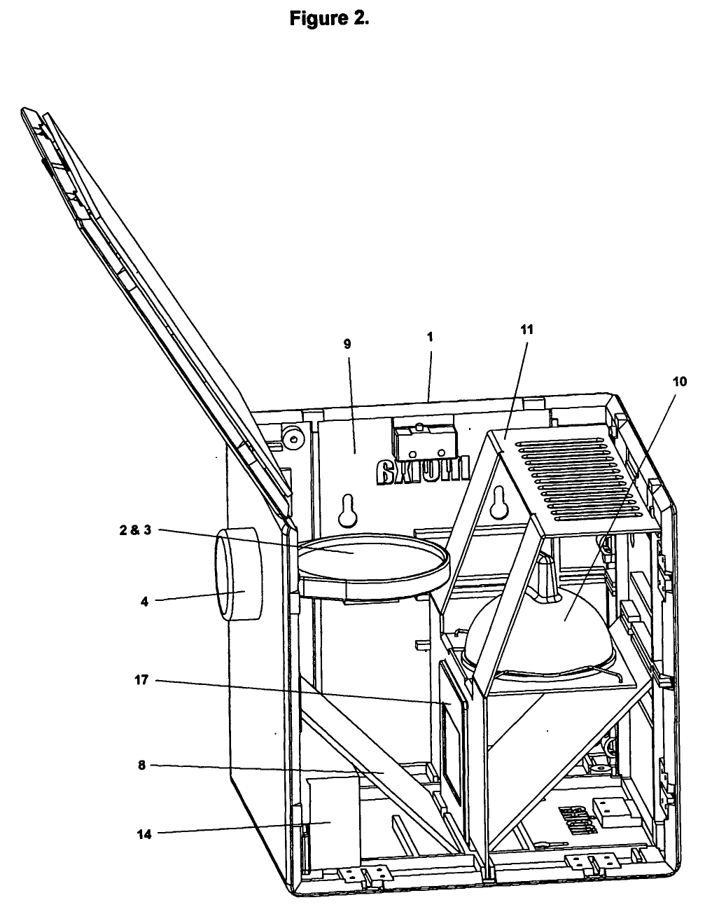

Referring now to FIG. 2, which shows the overall lamp and projection device 1 with one cube side 9 removed for clarity. The device comprises six identical side face panels 9 arranged at different rotations to form a cube. These interlock by means of protrusions 26 and recesses 20 on opposed faces. The left side casing 9 supports a lens assembly comprised of a lens 2 in a lens holder 3 bound between vertical struts 24 and is connected to a lens button 4 via a punched slot in the central groove 23 such that the overall lens assembly can be moved vertically. The device shows the metal bulb plate 11 supporting a bulb 10 and fixing into the cube sides 9 at groove slots 25. The slide 17 is shown in the centre of the cube 1 forming the main central axis and affixed into the slot 23 in the lower cube face panel 9. Reflecting mirrors 8 are shown on either side of the slide 17 at a forty-five degree angle to the slide and fixed by means of the edges of the central groove 23 in the respective cube panels 9 and form symmetrical diagonals on either side of the cube 1. FIG. 2 illustrates the overall simple lens geometry from bulb 10 projecting downwards and reflecting off the mirrors 8 through the slide 17 and up through the condensing lens 2 to a distance surface or off the mirrored lid 5 and 7 when angled. The figure also shows an internal transformer 14 positioned in the recess beneath the angled mirror 8.

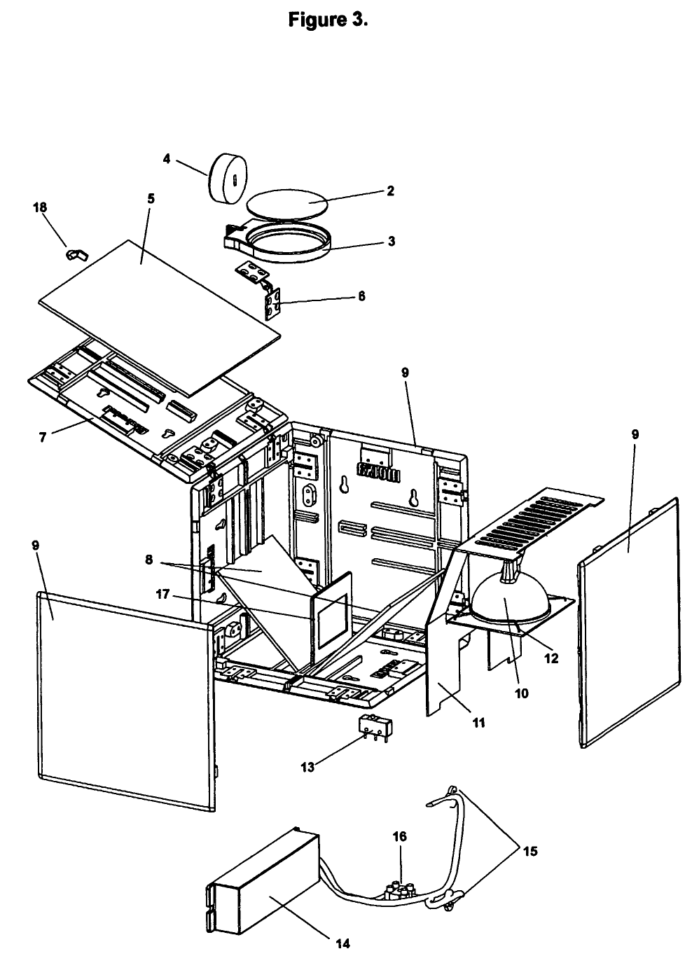

Referring now to FIG. 3 which shows an exploded view of all components forming the lamp and projection device. This figure shows how the six cube sides 9 are rotated to form an overall cube assembly and contain support structures in different places. The lid 7 is an identical part to 9 and affixes a mirror 5 across the inside surface and shows an external button clip 18 for ease of access when closed. Hinges 6 connect to the cube panel moulded recess 21 are also shown to connect the lid 7 to the rest of the cube assembly 1. Electrical components including a lid micro-switch 13, connector 16, wire clips 15 and low-voltage transformer 14 are also shown and arranged in a usual manner to connect to the bulb 10 and switches.

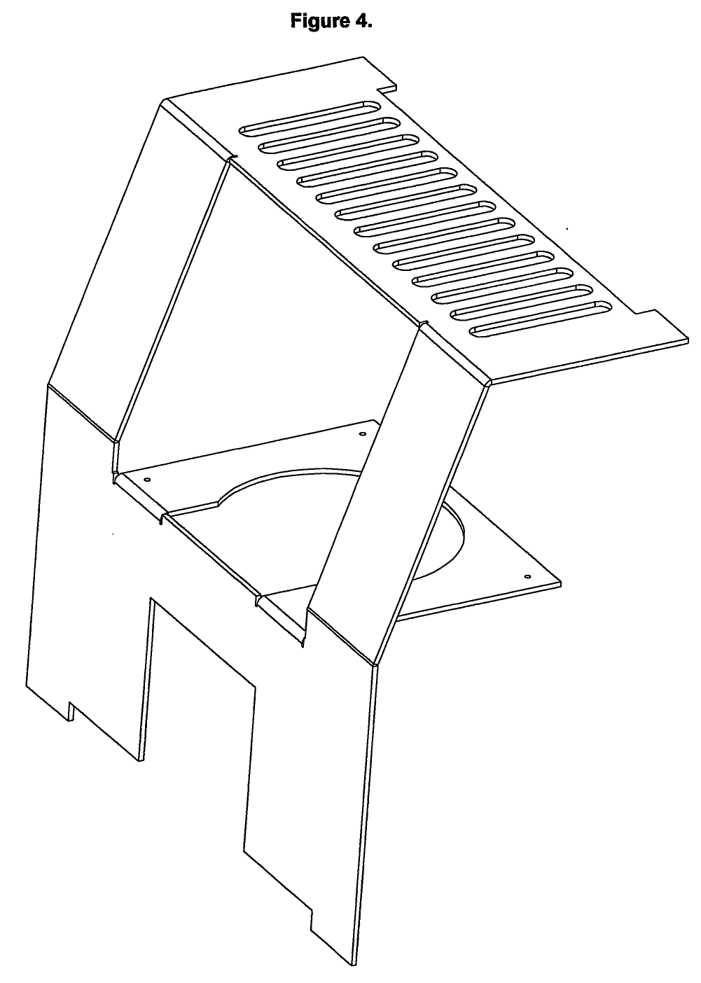

Referring now to FIG. 4 which shows a view of the metal bulb plate 11 in more detail. This would be formed from a single piece of die-cut and punched metal which is bent into the form illustrated and shows suitable venting at the top and open side sections to accommodate the slide 17, the bulb 10 and bulb locking wires 12, as well as an open front section to allow access for changing the bulb 10.

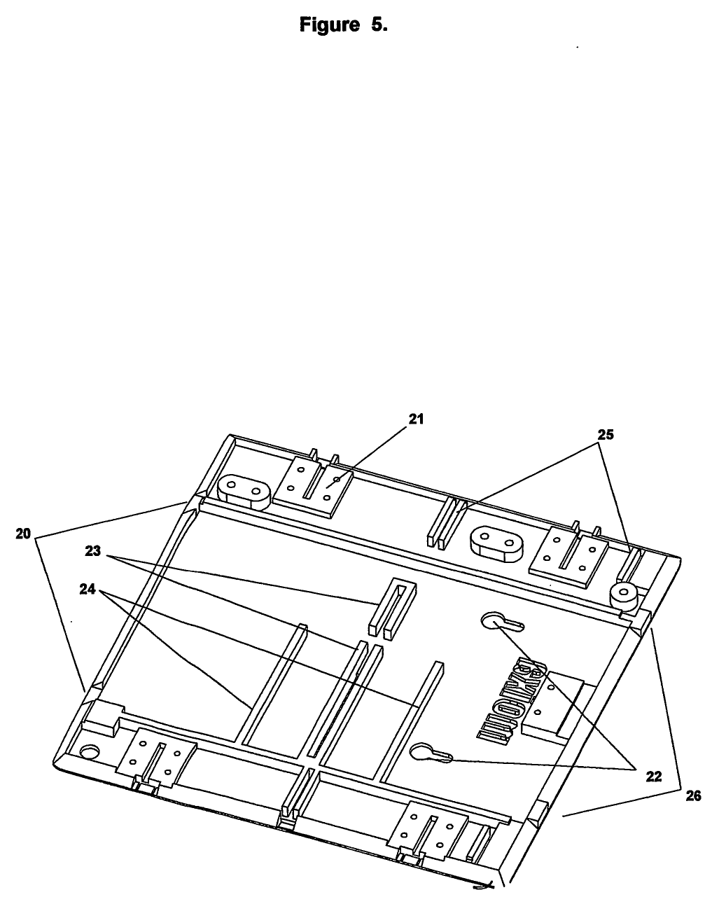

Referring now to FIG. 5 which shows a view of a single cube side panel 9, showing the various support structures of struts, and slots/grooves, such as the central groove 23, side supports 24, metal bulb plate supports 25, hinge recesses 21, edge protrusions 26 and recesses 20 for assembling the cube. These provide horizontal and vertical rigidity to the overall cube side panel 9 as well as supporting the parts of the illumination system. Punchable holes 22 for affixing to a wall are also shown.

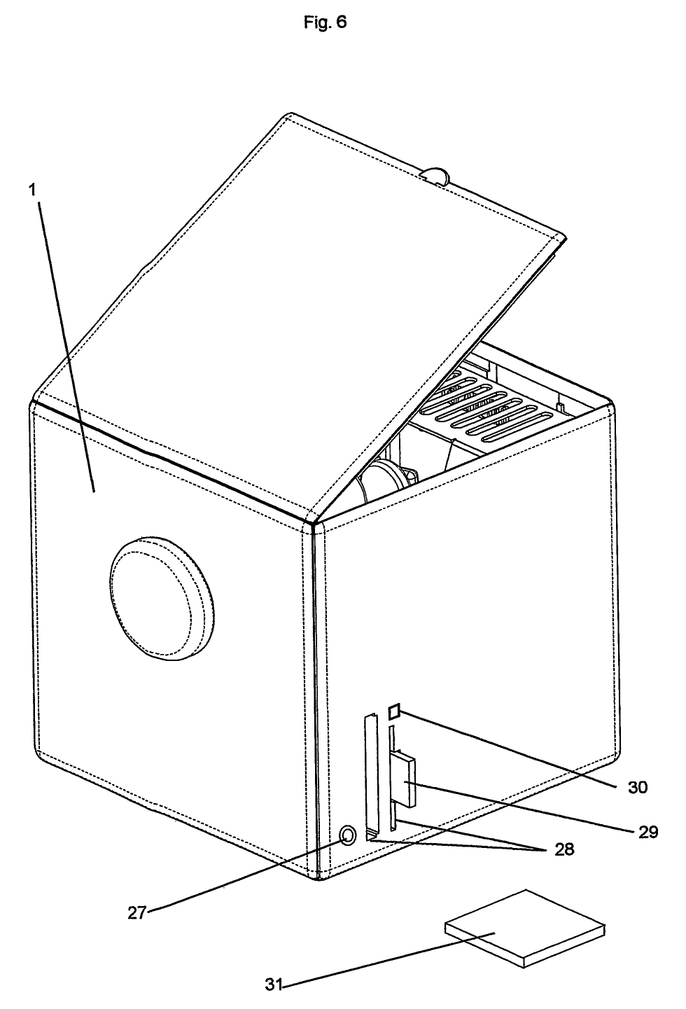

Referring now to FIG. 6 which shows a further embodiment of the overall projection device 1 which is shown to support external connector slots 28 for supporting removal digital media, 29, 31 which by way of example could be a flash data storage means, and wire connector slots 30 for a Bus connector such as a micro USB (Series B) or Firewire connection, together with external power supply 27. Similarly said device could support audio connections. Said media device 31 generally containing digital photograph images or video files (such as a DVD, or AVI format) capable of being projected via an internal digital means in place of the internal slide.

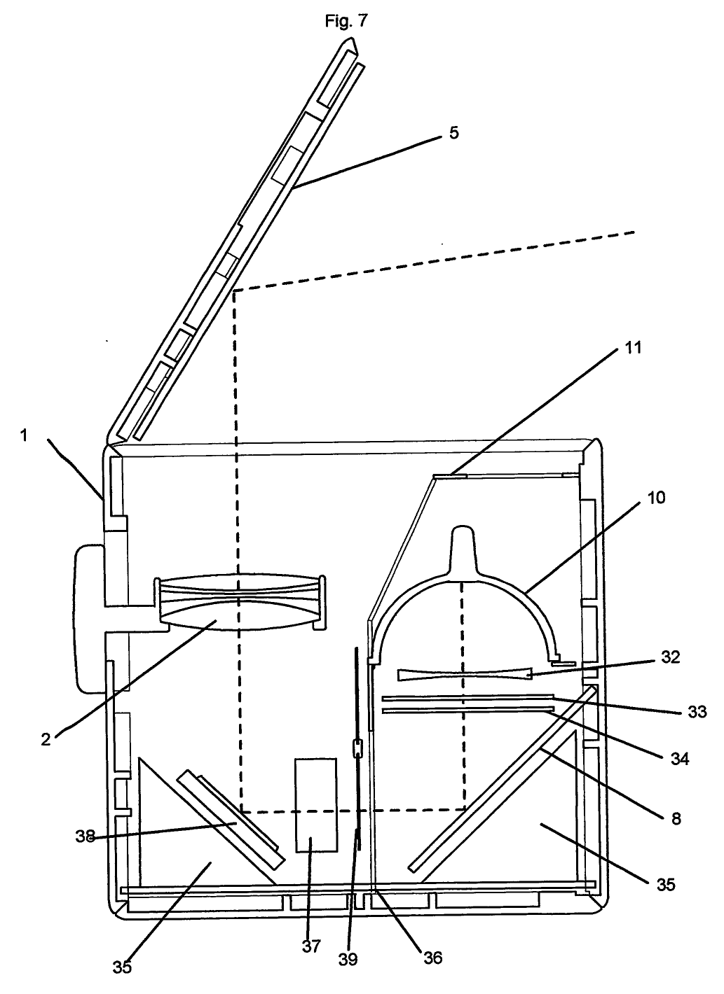

Referring now to FIG. 7 which shows a further preferred embodiment of the preferred internal slide projector arrangement of mirrors 8, bulb 10 and optics 2, where digital means 38 are used instead of a slide to make the overall projector device assembly a digital projector. Where for example a digital micro-mirror device 38 is used in place of the original corner mirror, and the remaining mirror 8 is a high luminosity reflecting mirror, the central slide has been replaced with a high speed rotating colour filter wheel 39 with light tunnel 37 to shield light passing onto the mirror device 38, which reflects through optical lenses 2 onto the upper mirror 5 treated with a high luminosity non-absorbing surface. Where said digital micro-mirror device 38 and colour wheel 39 are controlled by a micro-computer 35 that is supported on a motherboard 36 that is arranged parallel to the projection device base 1, and supports slots or recesses for enabling the overall internal assembly such as the bulb holder 11 to pass through and affix to the base 9. Where said bulb holder 11 preferably supports additional lens and filters such as a UV filter 33, condensing lens 32 and field lens 34. Where said micro-mirror device 38 could alternatively be implemented as a Liquid Crystal on Silicon panel with appropriate prism acting as a beam splitter.

Although the invention is described and illustrated with reference to one preferred embodiment and arrangement of support structures within the cube assembly it is expressly understood that it is in no way limited to the disclosure of such a preferred embodiment, but is capable of numerous modifications within the scope of the claims. By way of example the optical arrangement could be adjusted to house an additional lens beneath the bulb 10 or a fresnel lens could be used in place or alongside a reflecting mirror. Similarly the bulb 10 as illustrated is assumed to be a parabolic bulb with controlled illumination but could be adapted to function with a different light emitting source.

1. A lamp and projection device comprising:
a lamp body consisting of six substantially identical faces assembled to form a cube;
one of said faces being a hinged top face lid with interior mirrored surface capable of reflecting and projecting an image at various angles from vertical to horizontal;
support structure for supporting an imaging device and parts of an illumination and projection system; and
an illumination and projection system consisting of at least one lamp or light-emitting unit, a plurality of reflecting mirrors, at least one moveable condensing lens, and an electrical transformer and switch.

2. The lamp and projection device according to claim 1 wherein said six substantially identical faces are modular interlocking faces

3. The lamp and projection device according to claims 1 to 2 where said imaging device is a removable single slide

4. The lamp and projection device according to claim 1 where said imaging device is a digital means, such as a transparent LCD panel, LCOS panel, Digital micro-mirror or other digital imaging light engine

5. The lamp and projection device according to claims 1 to 4 where said faces are identical and contain recesses and protrusions at opposed edges such that they can be assembled by rotating appropriately and interlocked with similar parts in a cube arrangement.

6. The lamp and projection device according to claims 1 to 5 where said faces contain an internal support structure of struts and grooves for fixing the parts of the illumination system where such grooves support various parts or are not used depending on their rotation and position as a cube face.

7. The lamp and projection device according to claims 1 to 6 where said faces are formed from a semi-translucent material so as to provide soft illumination through the cube faces, and easily formed by injection moulding means.

8. The lamp and projection device according to claims 1 to 7 where a micro-switch is used to turn the device on or off as the top hinged lid is opened

9. The lamp and projection device according to claims 1 to 8 whereby a folded and punched metal sheet is used to support the bulb unit and provide suitable heat dispersion and venting.

10. The lamp and projection device according to claims 1 to 9 where said cube faces contain recessed grooves suitable for being punched through during manufacture or during installation to create holes or grooves suitable for alternative wire exit or for affixing the lamp to a surface or wall

11. The lamp and projection device according to claims 1 to 10 where a lens is supported in a lens holder tightly between vertical struts in the side-casing and connected through a punched groove in a side face to a control button to enable controlled vertical movement of the lens for focusing.

12. The lamp and projection device according to claims 1 to 11 whereby recessed regions passing almost all the way through the cube side faces are used to provide stronger areas of illumination or shadows for projecting ornamental lettering or symbols from the cube sides.

13. The lamp and projection device according to claims 1 to 12 supporting digital means comprised of a digital micro mirror device and associated light filters, lenses, rotating colour wheel and an electronic control system

14. The lamp and projection device according to claims 1 to 13 in combination with external connector sockets and connector slots to support removable digital data media for photograph or video content such that the overall device forms a digital photo projector cube

15. The lamp and projection device according to claims 1 to 14 where said overall device forms a digital projector cube suitable for video, gaming and computer display output

16. A lamp and projection device comprising a lamp body consisting of six identical modular and interlocking faces assembled by means of protrusions and recesses on opposed edges to form an overall cube with hinged top face lid that contains a mirrored inside surface and is capable of reflecting an image at various angles and acts to turn the device on by means of a micro-switch when opened, where said faces contain moulded support structures and grooves for providing rigidity to the overall device and for supporting parts of an illumination and projection system, and an illumination and projection system that consists of a folded sheet bulb holder, bulb, reflective mirrors, slide, condenser lens and movable lens holder, electrical transformer and switch components.
